(19) United States
(12) Patent Application Publication
(10) Pub. No.: US 2006/0139818 A1
(43) Pub. Date: Jun. 29, 2006

(54) Magnetic random access memory

(76) Inventors: Tsuneo Inaba, Kamakura-shi (JP); Masahiko Nakayama, Fuchu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/072,269

(22) Filed: Mar. 7, 2005

(30) Foreign Application Priority Data
Dec. 24, 2004 (JP) 2004-374966

(51) Int. Cl. G11B 5/33; G11B 5/127

(52) U.S. Cl. 360/324.12

(57) ABSTRACT

An MTJ element of a magnetic random access memory according to an example of the present invention comprises a first ferromagnetic layer whose magnetization direction is fixed, and a second ferromagnetic layer whose magnetization direction changes in accordance with an applied magnetic field. The second ferromagnetic layer comprises a main body having a long-axis direction, and a jut jutting in a direction different from that of a long axis from the main body.

### CROSS-REFERENCE TO RELATED APPLICATIONS

This application is based upon and claims the benefit of priority from the prior Japanese Patent Application No. 2004-374966, filed Dec. 24, 2004, the entire contents of which are incorporated herein by reference.

### BACKGROUND OF THE INVENTION

1. Field of the Invention

The present invention relates to the shape of a magnetoresistive element for use as a memory element of a magnetic random access memory (MRAM).

2. Description of the Related Art

A magnetic random access memory is a memory device utilizing a magnetoresistive effect. The device is nonvolatile, but has characteristics such as high speed, high integration, and high reliability. Therefore, the device has been noted as a replacement of all memory devices such as DRAM and EEPROM (see, e.g., IEEE Journal of Solid-State Circuits, Vol. 38, No. 5, May 2003, pp. 769 to 773, 2004 Symposium on VLSI Circuits Proceedings pp. 217 to 220).

As a memory element of the magnetic random access memory, for example, a magnetic tunnel junction (MTJ) element using a tunnel magnetoresistive effect (TMR) has been known.

The MTJ element comprises, for example, two ferromagnetic layers, and an insulating layer (tunnel barrier) disposed between the ferromagnetic layers. One of the two ferromagnetic layers is a pinned layer whose magnetization direction is fixed, and the other layer is a free layer whose magnetization direction changes in accordance with a magnetic field.

When the magnetization direction of the pinned layer is the same as that of the free layer, a magnetoresistive value of the MTJ element is smallest. This is regarded as a parallel state, and corresponds to, for example, “0”. When the magnetization direction of the pinned layer is reverse to that of the free layer, the magnetoresistive value of the MTJ element is largest. This is regarded as an anti-parallel state, and corresponds to, for example, “1”.

This magnetized state of the MTJ element is determined, for example, when the magnetic field is imparted to the free layer of the MTJ element, and the magnetization direction of the free layer is reversed. In this case, the magnetic field is generated, when a write current is passed through a write line.

However, in the present situation, the magnetic field required for reversing the magnetization direction of the free layer is large, and a value of the write current for producing the magnetic field is about several microamperes to several tens of microamperes. This value is excessively large in putting the magnetic random access memory to practical use, and therefore lowering of the write current is an important problem.

To realize the lowering of the write current without deteriorating thermal stability or resistance to disturbance, an asteroid curve of the MTJ element may be dented. A technique of controlling a magnetized pattern by the shape of the MTJ element has been proposed (see, e.g., Jpn. Pat. Appln. KOKAI Publication No. 2004-128067).

According to this technique, a shape (e.g., a cross shape) of the MTJ element capable of denting the asteroid curve has been proposed. However, since the shape is complicated, it is difficult to miniaturize the element, and there is a problem that the shape is not suitable for the high integration.

### BRIEF SUMMARY OF THE INVENTION

According to an aspect of the present invention, a magnetoresistive element comprises: a first ferromagnetic layer whose magnetization direction is fixed; and a second ferromagnetic layer whose magnetization direction changes in accordance with an applied magnetic field, the second ferromagnetic layer comprising: a main body having a long-axis direction; and a jut which juts from the main body in a direction different from the long-axis direction.

According to an aspect of the present invention, a magnetic random access memory comprises: a plurality of magnetoresistive elements each comprising a first ferromagnetic layer whose magnetization direction is fixed, and a second ferromagnetic layer whose magnetization direction changes in accordance with an applied magnetic field, and arranged in an array state; and a plurality of write lines each extending a first direction and for use in write data with respect to one of the plurality of magnetoresistive elements, the second ferromagnetic layer comprising: a main body having a long-axis direction; and a jut which juts from the main body in a direction different from the long-axis direction.

### BRIEF DESCRIPTION OF THE SEVERAL VIEWS OF THE DRAWING

FIG. 1 is a diagram showing a shape of a free layer as an idea of an example of the present invention;

FIG. 2 is a diagram showing a shape of the free layer of a magnetoresistive element according to a first embodiment;

FIG. 3 is a diagram showing a magnetization direction of the free layer;

FIG. 4 is a diagram showing a shape of the free layer of the magnetoresistive element according to a second embodiment;

FIG. 5 is a diagram showing a shape of the free layer of the magnetoresistive element according to a third embodiment;

FIG. 6 is a diagram showing a shape of the free layer of the magnetoresistive element according to the third embodiment;

FIG. 7 is a diagram showing a shape of the free layer of the magnetoresistive element according to the third embodiment;

FIG. 8 is a diagram showing a shape of the free layer of the magnetoresistive element according to the third embodiment;

FIG. 9 is a diagram showing a shape of the free layer of the magnetoresistive element according to a fourth embodiment;

FIG. 10 is a diagram showing a shape of the free layer of the magnetoresistive element according to the fourth embodiment;

FIG. 11 is a diagram showing a shape of the free layer of the magnetoresistive element according to a fifth embodiment;

FIG. 12 is a diagram showing a shape of the free layer of the magnetoresistive element according to the fifth embodiment;

FIG. 13 is a diagram showing a shape of the free layer of the magnetoresistive element according to the fifth embodiment;

FIG. 14 is a diagram showing a shape of the free layer of the magnetoresistive element according to the fifth embodiment;

FIG. 15 is a diagram showing a shape of the magnetoresistive element according to a sixth embodiment;

FIG. 16 is a sectional view along a line XVI-XVI of FIG. 15;

FIG. 17 is a diagram showing a shape of the magnetoresistive element according to a sixth embodiment;

FIG. 18 is a sectional view along a line XVIII-XVIII of FIG. 17;

FIG. 19 is a diagram showing a structure of the free layer of the magnetoresistive element according to a seventh embodiment;

FIG. 20 is a diagram showing a structure of the free layer of the magnetoresistive element according to the seventh embodiment;

FIG. 21 is a diagram showing a shape of the magnetoresistive element according to an eighth embodiment;

FIG. 22 is a diagram showing a shape of the magnetoresistive element according to a ninth embodiment;

FIG. 23 is a diagram showing a magnetic random access memory according to a tenth embodiment;

FIG. 24 is a diagram showing an example of a memory cell structure;

FIG. 25 is a diagram showing an example of the memory cell structure;

FIG. 26 is a diagram showing an example of the memory cell structure;

FIG. 27 is a diagram showing a positional relation of write lines according to an eleventh embodiment;

FIG. 28 is a diagram showing a positional relation of the write lines according to the eleventh embodiment;

FIG. 29 is a diagram showing a positional relation of the write lines according to the eleventh embodiment;

FIG. 30 is a diagram showing a positional relation of the write lines according to the eleventh embodiment;

FIG. 31 is a diagram showing a magnetic random access memory according to a twelfth embodiment;

FIG. 32 is a diagram showing a positional relation between the magnetoresistive element and the write line;

FIG. 33 is a diagram showing a magnetic random access memory according to the twelfth embodiment;

FIG. 34 is a diagram showing a positional relation between the magnetoresistive element and the write line;

FIG. 35 is a diagram showing a magnetic random access memory according to a thirteenth embodiment;

FIG. 36 is a diagram showing a positional relation between the magnetoresistive element and the write line;

FIG. 37 is a diagram showing a magnetic random access memory according to a fourteenth embodiment;

FIG. 38 is a diagram showing a positional relation between the magnetoresistive element and the write line;

FIG. 39 is a diagram showing a read circuit of the magnetic random access memory according to a fifteenth embodiment;

FIG. 40 is a diagram showing the read circuit of the magnetic random access memory according to the fifteenth embodiment;

FIG. 41 is a diagram showing the read circuit of the magnetic random access memory according to the fifteenth embodiment; and

FIG. 42 is a diagram showing the read circuit of the magnetic random access memory according to the fifteenth embodiment.

### DETAILED DESCRIPTION OF THE INVENTION

A magnetic random access memory of an aspect of the present invention will be described below in detail with reference to the accompanying drawing.

1. Outline

A shape of a magnetoresistive element according to an example of the present invention is characterized in that a free layer whose magnetization direction changes in accordance with a magnetic field comprises a main body portion having a long-axis direction, and a jut portion which juts from the main body portion in a direction different from the long-axis direction.

Here, a long axis refers to a long central line passing through a center of the main body portion, and the long-axis direction is a direction parallel to the long axis. A short-axis direction means a direction which crosses the long-axis direction at right angles.

When a direction of magnetic anisotropy is determined by the shape of the free layer (the magnetic anisotropy is referred to as a shape magnetic anisotropy), the direction of the magnetic anisotropy of the main body portion of the free layer agrees with the long-axis direction.

For example, the main body portion is formed into a rectangular shape whose long side is parallel to the long-axis direction, and accordingly the magnetic anisotropy (shape magnetic anisotropy) can be imparted in the long-axis direction. In this case, a magnetization easy axis direction which determines the direction of remaining magnetization of the main body portion is the long-axis direction, and the magnetization difficult axis direction is a short-axis direction.

Moreover, for example, the jut portion is formed into a rectangular shape whose long side is parallel to a direction different from the long-axis direction, and accordingly the magnetic anisotropy (shape magnetic anisotropy) can be imparted to the direction different from the long-axis direction. In this case, the magnetization easy axis direction which determines the direction of the remaining magnetization of the jut portion is a direction different from the long-axis direction.

It should be noted that the magnetic anisotropy is an idea indicating a direction to which the magnetization easily turns, and can be controlled by a type or composition of a material, a direction of (way of producing) a crystal axis, a shape and the like.

In the example of the present invention, there is only one jut portion that juts from the main body portion. The jut portion performs a function of assisting the reversing of the magnetization of the main body portion. Therefore, for example, the magnetic anisotropies of the main body portion and pinned layer are set in the same direction, and the magnetic anisotropy of the jut portion is set in a direction different from that of the pinned layer. A size of the jut portion is set to be smaller than that of the main body portion.

In this case, energy required for reversing the magnetization of the jut portion is set to be smaller than that required for reversing the magnetization of the main body portion.

Therefore, when a magnetic field is applied to the magnetoresistive element at the time of writing of data, the reversing of the magnetization of the jut portion proceeds, and this performs a traction function. The reversing of the magnetization of the main body portion also proceeds following that of the jut portion.

Since the jut portion assists the reversing of the magnetization of the main body portion in this manner, as a result, an asteroid curve of the magnetoresistive element can be dented.

As a result, an only switching magnetic field required for reversing the magnetization of the main body portion can be reduced without deteriorating thermal stability or resistance to disturbance. That is, a value of a write current required for reversing the magnetization can be reduced.

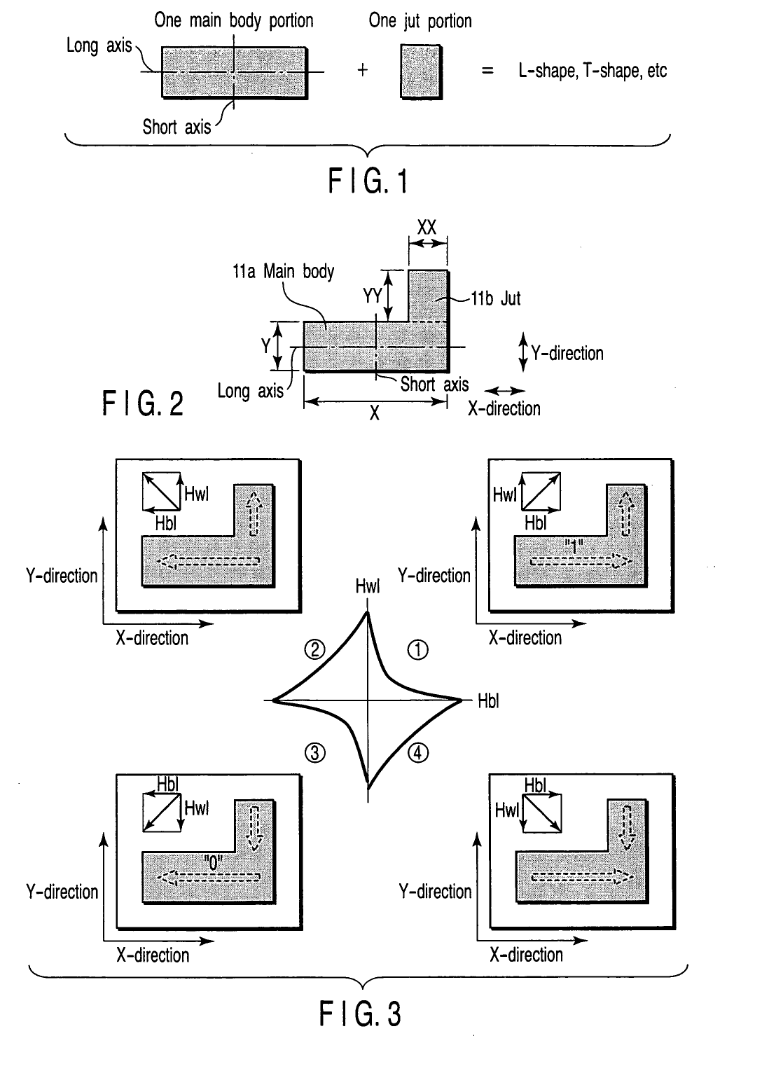

Additionally, in the example of the present invention, the free layer comprises the main body portion and the jut portion. For example, as shown in FIG. 1, the jut portion is connected to the main body portion in such a manner that the shape of the free layer is asymmetric with respect to the long axis. Examples of this shape include an L-shape, a T-shape and the like.

By this simple shape, the magnetoresistive element can be miniaturized as compared with a complicated shape such as a cross shape, and an increase of a memory capacity by high integration can be achieved.

It should be noted that according to the shape of the example of the present invention, an MR ratio largely depends on the direction of the remaining magnetization of the main body portion, and does not largely depend on the direction of the remaining magnetization of the jut portion.

2. Embodiment

Next, several embodiments considered to be best will be described.

### (1) First Embodiment

FIG. 2 shows a shape of a free layer of a magnetoresistive element according to a first embodiment.

The free layer comprises a main body 11a and a jut 11b.

The main body 11a has magnetic anisotropy in an X-direction (long-axis direction). Here, the main body 11a has a rectangular shape whose long side is X and whose short side is Y (>X), and the magnetic anisotropy is set by the shape. A direction of the magnetic anisotropy of the main body 11a is the same as a magnetization direction of a pinned layer. Additionally, the magnetization direction of the main body 11a can be changed by a magnetic field, and the magnetization direction of remaining magnetization is the same as (parallel to) or reverse (anti-parallel) to the magnetization direction of the pinned layer.

The jut 11b has magnetic anisotropy in a direction different from the X-direction, which is a Y-direction (short-axis direction) crossing the X-direction at right angles. Here, the jut 11b has a rectangular shape whose long side is YY and whose short side is XX (>YY), and magnetic anisotropy is set by the shape. The direction of the magnetic anisotropy of the jut 11b is different from the magnetization direction of the pinned layer. Therefore, energy required for reversing the magnetization of the jut 11b is smaller than that required for reversing the magnetization of the main body 11a.

The jut 11b is physically connected to the main body 11a. In the present embodiment, the jut 11b juts from the long side of the main body (rectangular shape) 11a.

The free layer has an L-shape as a whole.

Additionally, a size of the jut 11b is smaller than that of the main body 11a, and the shape of the whole free layer is asymmetric with respect to the long axis.

Concretely, the long side (maximum value of a length) YY of the jut (rectangular shape) 11b is smaller than the long side (maximum value of the length) X of the main body (rectangular shape) 11a, and the short side (maximum value of a width) XX of the jut 11b is smaller than a short side (maximum value of the width) Y of the main body 11a.

When a magnetic field for reversing magnetization is applied to the magnetoresistive element, first the reversing of the magnetization of the jut 11b proceeds, and that of the main body 11a accordingly proceeds.

For example, as shown in state 1 of FIG. 3, when data “1” is stored, the magnetization direction (direction of remaining magnetization) of the main body is set to a right direction. At this time, the magnetization direction of the jut is set to an upward direction. The magnetization direction of the whole free layer extends along the shape (L-shape) of the free layer.

When the magnetization is reversed from this state, and data “0” is written in the magnetoresistive element, as shown in state 3 of FIG. 3, for example, a synthesized magnetic field Hwl+Hbl is imparted to the magnetoresistive element.

Here, Hwl is a magnetic field produced by a write current flowing through a word line WL, and Hbl is a magnetic field produced by a write current flowing through a bit line BL intersecting the word line WL.

In this case, first the reversing of the magnetization of the jut proceeds, this performs a traction function, and the reversing of the magnetization of the main body also proceeds following that of the jut. Since the magnetized state of the jut assists the reversing of the magnetization of the main body in this manner, the reversing of the magnetization of the whole free layer easily occurs. As a result, the asteroid curve is dented (state 3).

Moreover, as shown in the state 3 of FIG. 3, when data “0” is stored, the magnetization direction (direction of the remaining magnetization) of the main body is set to a left direction, and the magnetization direction of the jut is a downward direction. The magnetization direction of the whole free layer extends along the shape (L-shape) of the free layer.

When the magnetization is reversed from this state, and data “1” is written in the magnetoresistive element, as shown in state 1 of FIG. 3, for example, the synthesized magnetic field Hwl+Hbl is imparted to the magnetoresistive element.

In this case, first the reversing of the magnetization of the jut proceeds, this performs a traction function, and the reversing of the magnetization of the main body also proceeds following that of the jut. Since the magnetized state of the jut assists the reversing of the magnetization of the main body in this manner, the reversing of the magnetization of the whole free layer easily occurs. As a result, the asteroid curve is dented (state 1).

It should be noted that in states 2, 4 of FIG. 3, a magnetic wall is produced between the main body and the jut, and the magnetization direction of the whole free layer does not extend along the shape of the free layer.

In this case, the magnetized state of the jut inhibits the magnetization of the main body from being reversed, the magnetization of the whole free layer is not easily reversed, and the asteroid curve is not dented.

Therefore, in the example of the present invention, the magnetized state of the magnetoresistive element is controlled in such a manner as to use the states 1, 3 of FIG. 3.

In the first embodiment, the L-shaped magnetoresistive element asymmetric with respect to the long axis has been described. According to the shape, the asteroid curve is dented, and the write current can be reduced. Moreover, the shape is capable of contributing to high integration of the magnetoresistive element by the miniaturization.

### (2) Second Embodiment

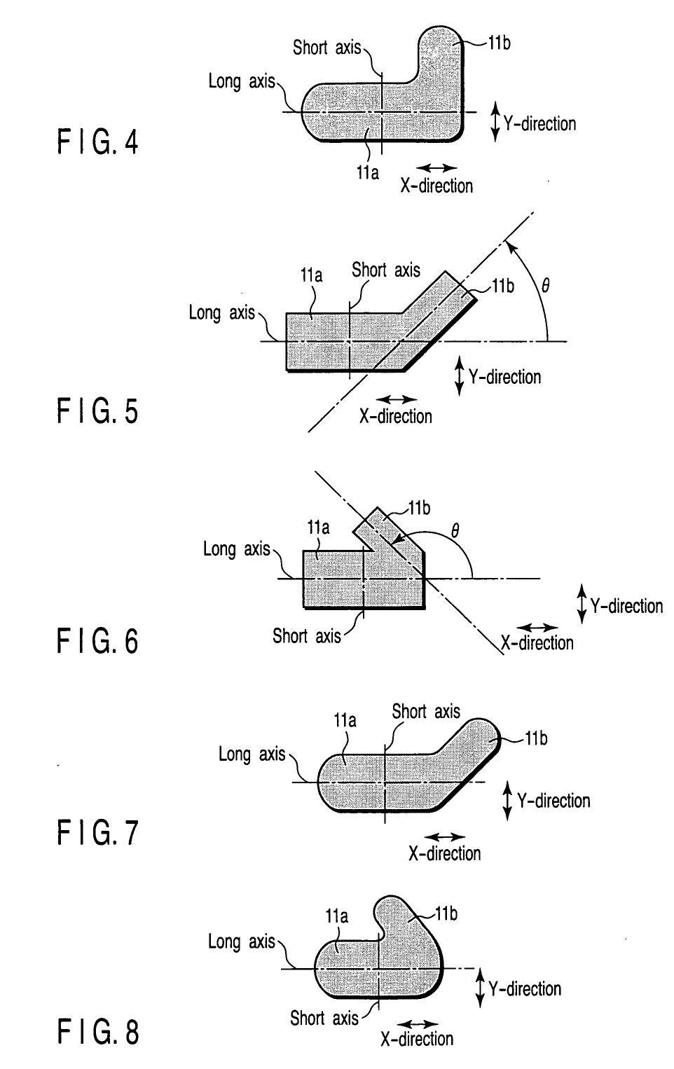

FIG. 4 shows a shape of a free layer of a magnetoresistive element according to a second embodiment. This magnetoresistive element has all the characteristics of the magnetoresistive element of the first embodiment. The magnetoresistive element of the second embodiment is different from that of the first embodiment in that corner portions and connected portions of a main body 11a and a jut 11b are rounded.

Usually, the magnetoresistive element is formed by etching using a mask material formed by a photolithography technique as a mask. However, when the magnetoresistive element is miniaturized, contours of the corner portions and connected portions are blurred and rounded in many cases. That is, even when the main body 11a and the jut 11b are designed to be quadrangular, the corner portions and the connected portions of the main body 11a and the jut 11b are rounded in an actually formed magnetoresistive element.

This roundness is effective for preventing an MR ratio by an edge domain from being lowered. Therefore, the corner portions and the connected portions of the main body 11a and the jut 11b may be rounded regardless of resolution of photolithography, and the drop of the MR ratio by the edge domain may be prevented.

Here, the edge domain is a phenomenon in which the magnetization in an edge portion is directed along an edge. It is known that the edge domain is a cause for lowering the MR ratio, and a ratio of the drop of the MR ratio by the edge domain increases as miniaturization of the magnetoresistive element advances.

Therefore, in achieving high integration of the magnetoresistive element, it is very effective to round the corner portions and the connected portions of the main body 11a and the jut 11b and to prevent the drop of the MR ratio by the edge domain as in the second embodiment.

### (3) Third Embodiment

FIGS. 5 to 8 show shapes of a free layer of a magnetoresistive element according to a third embodiment.

The magnetoresistive element comprises all characteristics of the magnetoresistive element of the first embodiment except the shape of the whole free layer. The magnetoresistive element of the third embodiment is different from that of the first embodiment in that a direction of magnetic anisotropy of a jut 11b can be freely set in a range of 0°<θ<180° with respect to a direction of magnetic anisotropy of a main body 11a.

That is, the magnetic anisotropy of the jut 11b may exist in a direction other than a Y-direction crossing the direction (X-direction) of the magnetic anisotropy of the main body 11a at right angles.

For example, in an example of FIG. 5, the magnetic anisotropy of the jut 11b exists in a direction of an angle less than 90° with respect to the direction of the magnetic anisotropy of the main body 11a. In an example of FIG. 6, the magnetic anisotropy of the jut 11b exists in a direction of an angle exceeding 90° with respect to the direction of the magnetic anisotropy of the main body 11a.

By this shape, in addition to an effect obtained by the first embodiment, further an effect capable of increasing an MR ratio and a read signal amount can be obtained.

It should be noted that an angle θ of the direction of the magnetic anisotropy of the main body 11a with respect to that of the magnetic anisotropy of the jut 11b is preferably in a range of 30° or more and 150° or less in consideration of ease of production or the like.

Moreover, as shown in FIGS. 7 and 8, corner portions and connected portions of the main body 11a and jut 11b may be rounded.

### (4) Fourth Embodiment

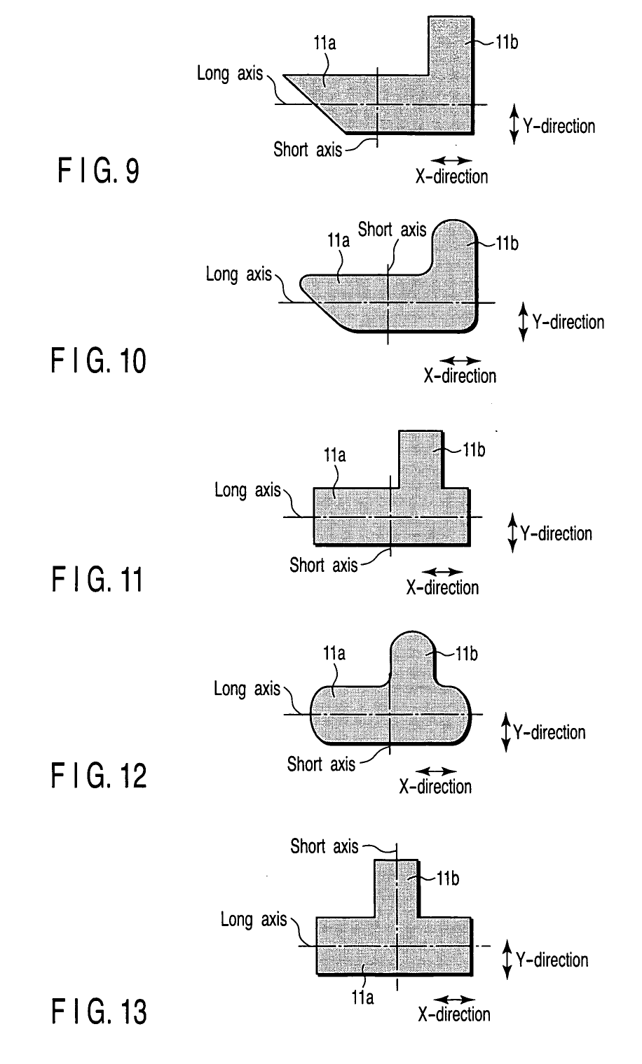

FIGS. 9 and 10 show shapes of a free layer of a magnetoresistive element according to a fourth embodiment.

This magnetoresistive element has all the characteristics of the magnetoresistive element of the first embodiment except the shape of a main body 11a. The magnetoresistive element of the fourth embodiment is different from that of the first embodiment in that a tip portion of the main body (rectangular shape) 11a is cut off in such a manner as to form a tapered shape.

The taper of the main body 11a is added in such a manner as to form an acute angle on a side of the main body connected to a jut 11b.

By this shape, in addition to an effect obtained by the first embodiment, further an effect capable of reducing an edge domain can be obtained, and the present embodiment is capable of contributing to enhancement of an MR ratio.

It should be noted that, as shown in FIG. 10, corner portions and connected portions of the main body 11a and jut 11b may be rounded.

### (5) Fifth Embodiment

FIGS. 11 to 14 show shapes of a free layer of a magnetoresistive element according to a fifth embodiment.

This magnetoresistive element has all the characteristics of the magnetoresistive element of the first embodiment except the shape of the whole free layer. The magnetoresistive element of the fifth embodiment is different from that of the first embodiment in that a connected portion between a main body 11a and a jut 11b does not exist on an end portion of a long side of the main body 11a, but exists inside the end portion.

That is, in the fifth embodiment, the shape of the whole free layer is approximately a T-shape rather than an L-shape.

For example, in an example of FIG. 11, the jut 11b is physically connected to the main body 11a in a position slightly inside the end portion of the long side of the main body 11a. In an example of FIG. 13, the jut 11b is physically connected to the main body 11a in the very middle or in a substantial middle of the long side of the main body 11a.

Even in this shape, an effect similar to that obtained by the first embodiment can be obtained.

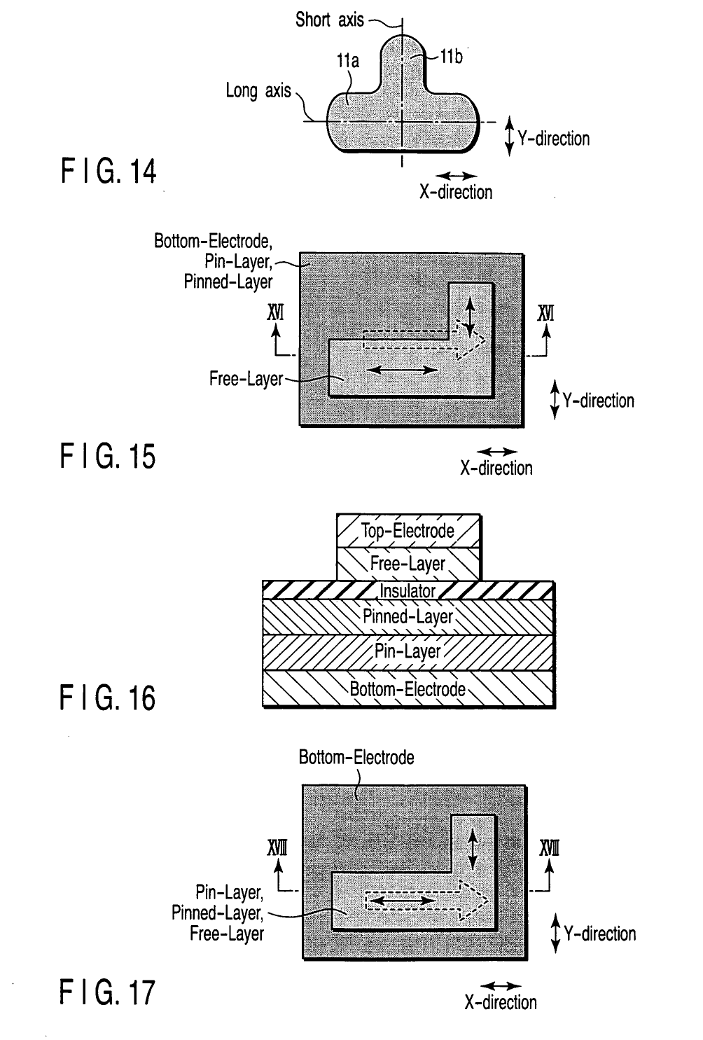

It should be noted that, as shown in FIGS. 12 and 14, corner portions and connected portions of the main body 11a and jut 11b may be rounded.

### (6) Sixth Embodiment

A sixth embodiment relates to a relation between a shape of a free layer and that of a pinned layer.

FIGS. 15 to 18 show shapes of a magnetoresistive element according to the sixth embodiment.

As the shape of the free layer, any of the examples of the first to fifth embodiment can be adopted, but here the L-shape of the first embodiment will be described as an example.

The pinned layer has a quadrangular shape, and completely covers the free layer as viewed in a plane manner from a semiconductor substrate.

A direction of magnetic anisotropy of the pinned layer is the same as that of the magnetic anisotropy of a main body of the free layer, and is an X-direction. The pinned layer has a rectangular shape close to a square shape, and therefore has small shape magnetic anisotropy. Therefore, the pinned layer is constituted, for example, in such a manner that a crystal axis magnetic anisotropy obtained by imparting the magnetic anisotropy by a crystal axis of a material constituting the pinned layer becomes larger than the shape magnetic anisotropy.

FIGS. 15 and 16 show an example in which the shape of the free layer is different from that of the pinned layer.

A bottom electrode, pin layer, pinned layer, and tunnel barrier (insulator) have the same shape (quadrangular shape).

The pinned layer comprises an antiferromagnetic layer (pin layer) and a ferromagnetic layer (pinned layer). The ferromagnetic layer constituting the pin layer has its magnetization direction fixed by an exchange coupling force with the antiferromagnetic layer.

The free layer and a top electrode have the same shape (L-shape), and the shape is different from that of each of the bottom electrode, pin layer, pinned layer, and tunnel barrier.

The bottom electrode, pin layer, pinned layer, and tunnel barrier are worked once by etching using a first mask, and the free layer and top electrode are worked once by etching using a second mask which is different from the first mask.

It should be noted that a broken-line arrow indicates a magnetization direction of the pin layer or the pinned layer, and a solid-line arrow indicates a magnetization direction of the free layer.

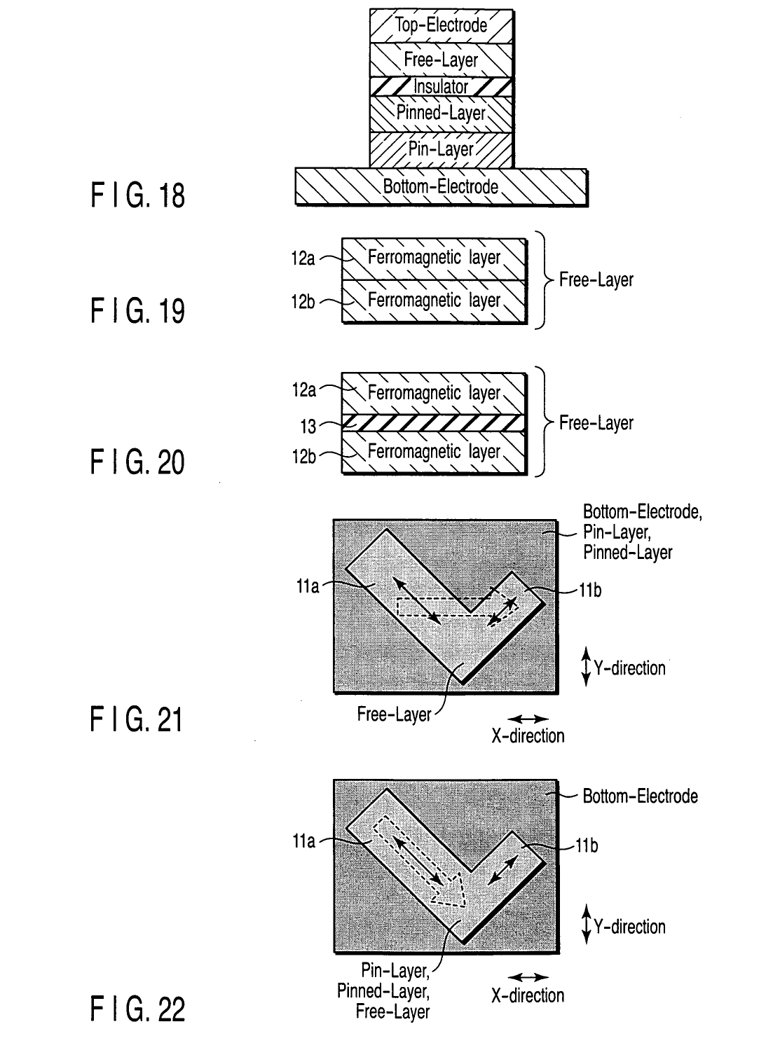

FIGS. 17 and 18 show an example in which the shape of the free layer is the same as that of the pin layer or the pinned layer.

The bottom electrode has a quadrangular shape.

The pin layer, pinned layer, tunnel barrier (insulator), free layer, and top electrode have the same shape (L-shape), and the shape is different from that of the bottom electrode.

The pinned layer comprises the antiferromagnetic layer (pin layer) and the ferromagnetic layer (pinned layer). The ferromagnetic layer constituting the pinned layer has its magnetization direction fixed by the exchange coupling force with the antiferromagnetic layer.

The pin layer, pinned layer, tunnel barrier, free layer, and top electrode are worked once by the etching using the first mask. The bottom electrode is worked by the etching using the second mask which is different from the first mask.

It should be noted that a broken-line arrow indicates a magnetization direction of the pin layer or the pinned layer, and a solid-line arrow indicates a magnetization direction of the free layer.

### (7) Seventh Embodiment

A seventh embodiment relates to a structure of a free layer.

FIGS. 19 and 20 show the structures of the free layer of the magnetoresistive element according to the seventh embodiment.

The free layer may comprise one ferromagnetic layer. However, for example, as shown in FIG. 19, the layer may comprise two ferromagnetically or antiferromagnetically coupled ferromagnetic layers 12a, 12b. In this structure, since an asteroid curve largely elongates in a magnetization difficult axis direction, thermal stability or resistance to disturbance can be enhanced.

Moreover, for example, as shown in FIG. 20, the free layer may comprise two ferromagnetically or antiferromagnetically coupled ferromagnetic layers 12a, 12b, and an insulating layer (nonmagnetic layer) 13 disposed between the ferromagnetic layers. Even in this structure, the asteroid curve can largely elongate in the magnetization difficult axis direction, and the thermal stability or resistance to disturbance can be enhanced.

### (8) Eighth Embodiment

FIG. 21 shows a shape of a magnetoresistive element according to an eighth embodiment.

A bottom electrode, pin layer, pinned layer, and tunnel barrier (insulator) have quadrangular shapes. The pin layer or the pinned layer has magnetic anisotropy in an X-direction, and a magnetization direction is fixed in a right direction as shown by a broken-line arrow.

A free layer and a top electrode have L-shapes. The free layer comprises a main body 11a and a jut 11b.

A direction of magnetic anisotropy of the main body 11a is different from that (X-direction) of magnetic anisotropy of the pinned layer. The main body 11a has, for example, a rectangular shape, and the magnetic anisotropy is set by the shape. The magnetization direction of the main body 11a can be changed by a magnetic field. The magnetization direction of remaining magnetization is close to that of the pinned layer (parallel), or close to a direction (anti-parallel) close to a reverse direction with respect to the magnetization direction of the pinned layer as shown by solid-line arrows.

The jut 11b has magnetic anisotropy in a direction different from the magnetization direction of the main body 11a, that is, a direction crossing the magnetization direction of the main body 11a at right angles in this example. The direction of the magnetic anisotropy of the jut 11b is also different from that (X-direction) of the magnetic anisotropy of the pinned layer. The jut 11b has, for example, a rectangular shape, and the magnetic anisotropy is set by the shape. Energy required for reversing magnetization of the jut 11b is smaller than that required for reversing magnetization of the main body 11a.

The jut 11b is physically connected to the main body 11a. In the present example, the jut 11b juts from a long side of the main body (rectangular shape) 11a.

The free layer has an L-shape as a whole.

Additionally, a size of the jut 11b is smaller than that of the main body 11a, and the shape of the whole free layer is asymmetric with respect to a long axis.

Even in this shape, an asteroid curve can be dented, a write current can be reduced. Moreover, the present embodiment can contribute to high integration of the magnetoresistive element by miniaturization.

### (9) Ninth Embodiment

FIG. 22 shows a shape of a magnetoresistive element according to a ninth embodiment.

A bottom electrode has a quadrangular shape.

A pin layer, pinned layer, tunnel barrier (insulator), free layer, and top electrode have L-shapes. Each of the free layer, pin layer, and pinned layer comprises a main body 11a and a jut 11b.

The main body 11a has, for example, a rectangular shape, and magnetic anisotropy is set by the shape. Magnetization directions of the main body 11a and jut 11b of the pin layer or pinned layer are fixed as shown by a broken-line arrow. The magnetization direction of the main body 11a of the free layer can be changed by a magnetic field, and the magnetization direction of remaining magnetization is set to the same direction (parallel) as that of the pinned layer, or to be reverse (anti-parallel) to the magnetization direction of the pinned layer as shown by solid-line arrows.

The jut 11b has magnetic anisotropy in a direction different from the magnetization direction of the main body 11a of the free layer, for example, a direction crossing the magnetization direction of the main body 11a of the free layer at right angles in the present example. The jut 11b of the free layer has, for example, a rectangular shape, and the magnetic anisotropy is set by the shape.

Energy required for reversing the magnetization of the jut 11b of the free layer is smaller than that required for reversing the magnetization of the main body 11a of the free layer.

The jut 11b is physically connected to the main body 11a. In the present example, the jut 11b juts from a long side of the main body (rectangular shape) 11a.

The free layer and the pinned layer have L-shapes as a whole.

Additionally, a size of the jut 11b is smaller than that of the main body 11a, and the shape of the whole free layer is asymmetric with respect to a long axis.

Also in this shape, an asteroid curve can be dented, and a write current can be reduced. Moreover, the present embodiment can also contribute to high integration of the magnetoresistive element by miniaturization.

### (10) Tenth Embodiment

A tenth embodiment relates to a magnetic random access memory using an magnetoresistive element according to the first to ninth embodiments.

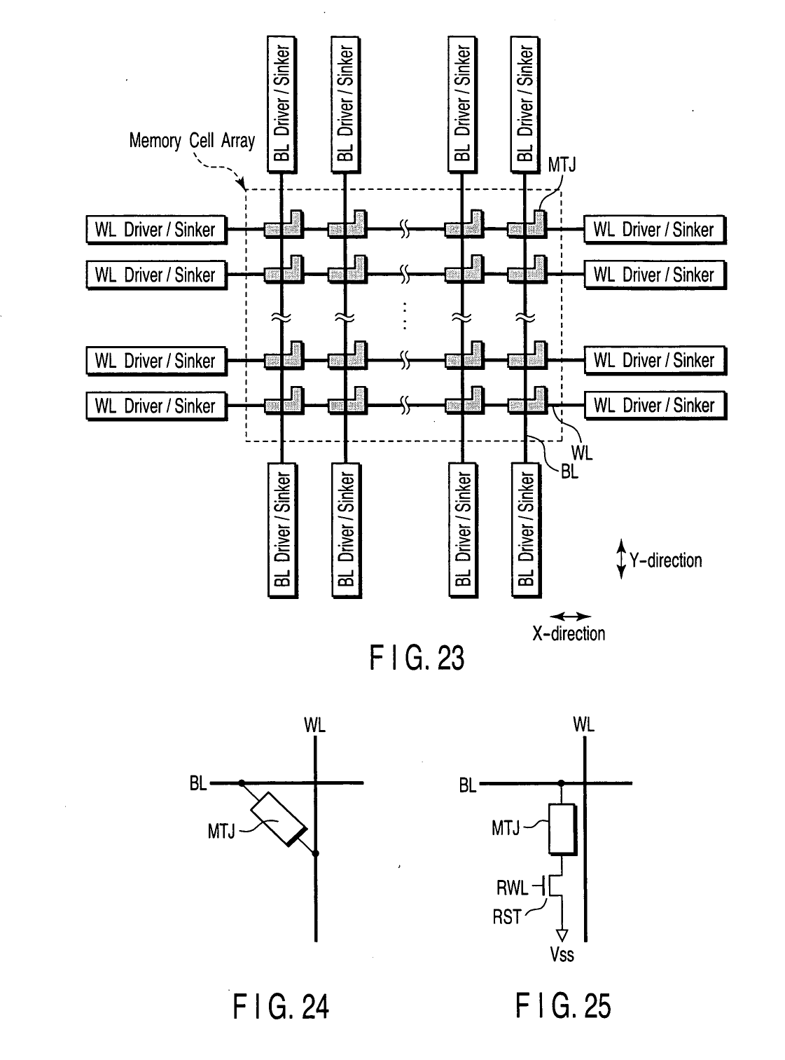

FIG. 23 shows an outline of a memory cell array of the magnetic random access memory according to the tenth embodiment.

The magnetic random access memory of the present example adopts a so-called biaxial write system in which data is written with respect to one magnetoresistive element (MTJ element) using two intersecting write lines.

The memory cell array comprises a plurality of magnetoresistive elements MTJ arranged in an array state. In the memory cell array, a plurality of word lines WL extending in an X-direction, and a plurality of bit lines BL extending in a Y-direction are arranged.

Opposite ends of the plurality of word lines WL are connected to, for example, a plurality of word line drivers/sinkers (WL drivers/sinkers), and opposite ends of the plurality of bit lines BL are connected to a plurality of bit line drivers/sinkers (BL drivers/sinkers).

Various types are applied as a memory cell structure. Several representative structures will be described hereinafter.

The memory cell structure shown in FIG. 24 is a so-called cross point type in which only one magnetoresistive element MTJ is disposed in an intersecting portion of two write lines, that is, the word line WL and the bit line BL. According to this structure, a selection element is not required. Therefore, the MTJ elements can be arranged in a densest manner in a range permitted by a lithography technique, and the present embodiment can contribute to an increase of memory capacity.

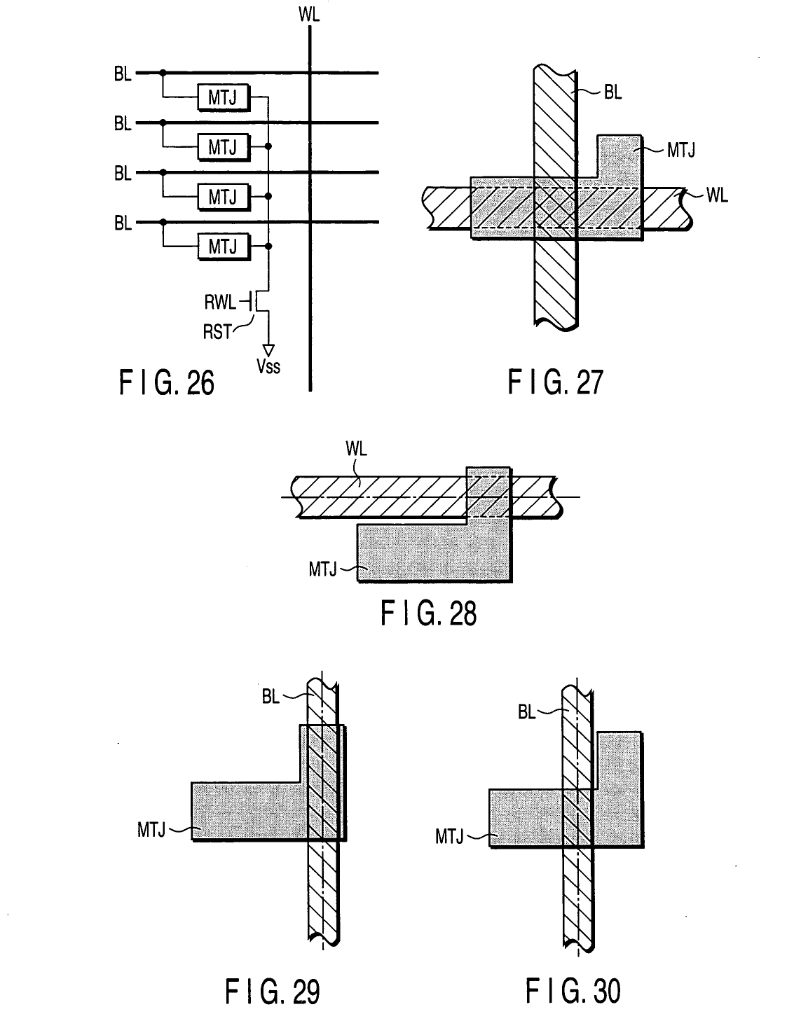

A memory cell structure shown in FIG. 25 is a so-called 1Tr-1MTJ type in which one selection element (MOS transistor) RST is connected to one magnetoresistive element MTJ. According to this structure noises at the time of reading are reduced by the selection element RST, and read selection property can be enhanced.

A memory cell structure shown in FIG. 26 is a so-called 1Tr-nMTJ type in which one selection element (MOS transistor) RST is connected to n (n is a plurality of) magnetoresistive elements MTJs. According to this structure, the enhancement of the selection property as well as high integration close to that of the cross point type can be realized.

### (11) Eleventh Embodiment

An eleventh embodiment relates to a positional relation between a magnetoresistive element and a write line.

FIGS. 27 to 30 show positional relations between the magnetoresistive element of a magnetic random access memory according to the eleventh embodiment, and a write line according to the eleventh embodiment.

In an example of FIG. 27, a word line (write line) WL passes through a middle of a main body of a free layer of a magnetoresistive element MTJ. In the present example, the word line WL is disposed right under the magnetoresistive element MTJ, but may be disposed right on the element. A bit line (write line) BL also passes through the middle of the main body of the free layer of the magnetoresistive element MTJ. In the present example, the bit line BL is disposed right on the magnetoresistive element MTJ, but may be disposed right under the element.

In an example of FIG. 28, a word line (write line) WL passes through a middle of a jut of a free layer of a magnetoresistive element MTJ. By this positional relation, a magnetic field Hwl produced by a write current flowing through the word line WL can be efficiently supplied to the jut.

It should be noted that in the present example, the position of the bit line (write line) BL is not especially limited, and is omitted here. The word line WL is disposed right under the magnetoresistive element MTJ, but may be disposed right on the element.

In an example of FIG. 29, a bit line (write line) BL passes through a middle of a jut of a free layer of a magnetoresistive element MTJ. By this positional relation, a magnetic field Hbl produced by a write current flowing through the bit line BL can be efficiently supplied to the jut.

It should be noted that in the present example, the position of the word line (write line) WL is not especially limited, and is omitted here. The bit line BL is disposed right on the magnetoresistive element MTJ, but may be disposed right under the element.

In an example of FIG. 30, a bit line (write line) BL passes right under or right on a main body of a free layer of a magnetoresistive element MTJ (including a portion other than a middle of the free layer). By this positional relation, a magnetic field Hbl produced by a write current flowing through the bit line BL can be efficiently supplied to the main body.

It should be noted that in the present example, the position of the word line (write line) WL is not especially limited, and is omitted here. The bit line BL is disposed right on the magnetoresistive element MTJ, but may be disposed right under the element.

### (12) Twelfth Embodiment

A twelfth embodiment relates to directions of a plurality of magnetoresistive elements constituting a memory cell array.

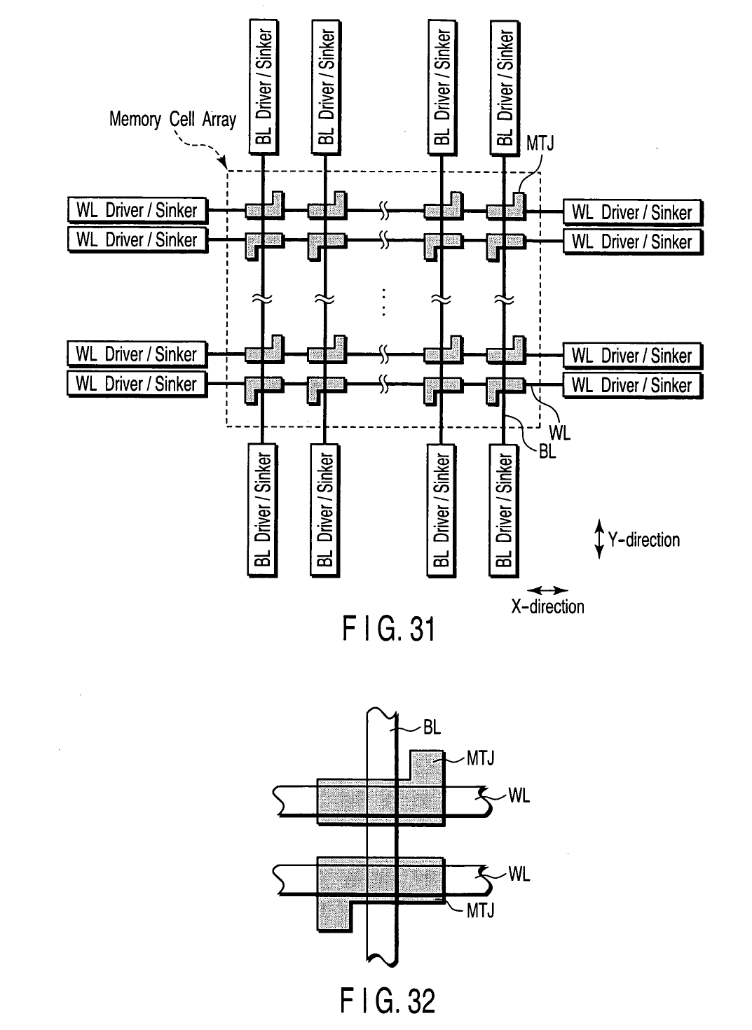

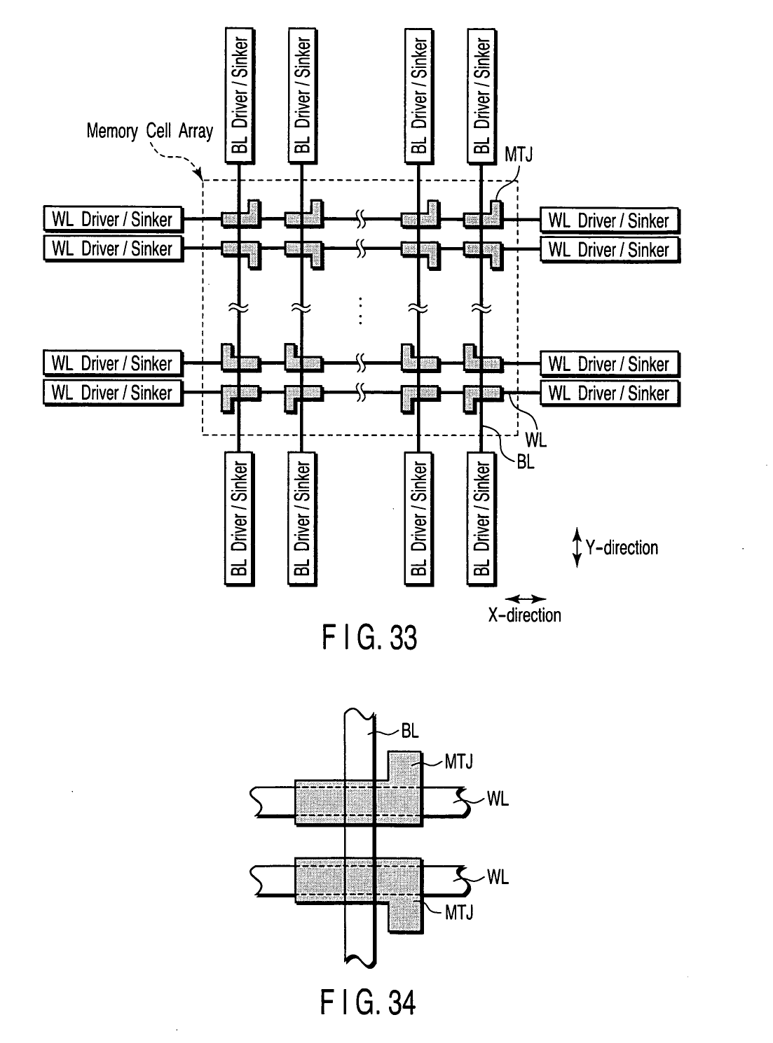

FIGS. 31 to 34 show outlines of a memory cell array of a magnetic random access memory according to the twelfth embodiment.

In the memory cell array (FIG. 23) described above in the tenth embodiment, all the magnetoresistive elements MTJ are directed in the same direction.

In this case, a layout is simple. Especially, when a memory cell structure (e.g., memory cell structure shown in FIG. 25 or 26) using a selection element is adopted, a problem occurs that an area per memory cell increases.

Therefore, especially when a memory cell structure using a selection element is adopted, as in the twelfth embodiment, for example, two magnetoresistive elements adjacent to a Y-direction (row direction) are arranged point-symmetrically or line-symmetrically among a plurality of magnetoresistive elements constituting a memory cell array.

In this case, for example, drain regions of two selection elements (MOS transistors) corresponding to these two magnetoresistive elements can be shared, therefore an area per memory cell is reduced, and high integration can be realized.

### (13) Thirteenth Embodiment

A thirteenth embodiment relates to a memory cell array of a magnetic random access memory adopting a toggle write system.

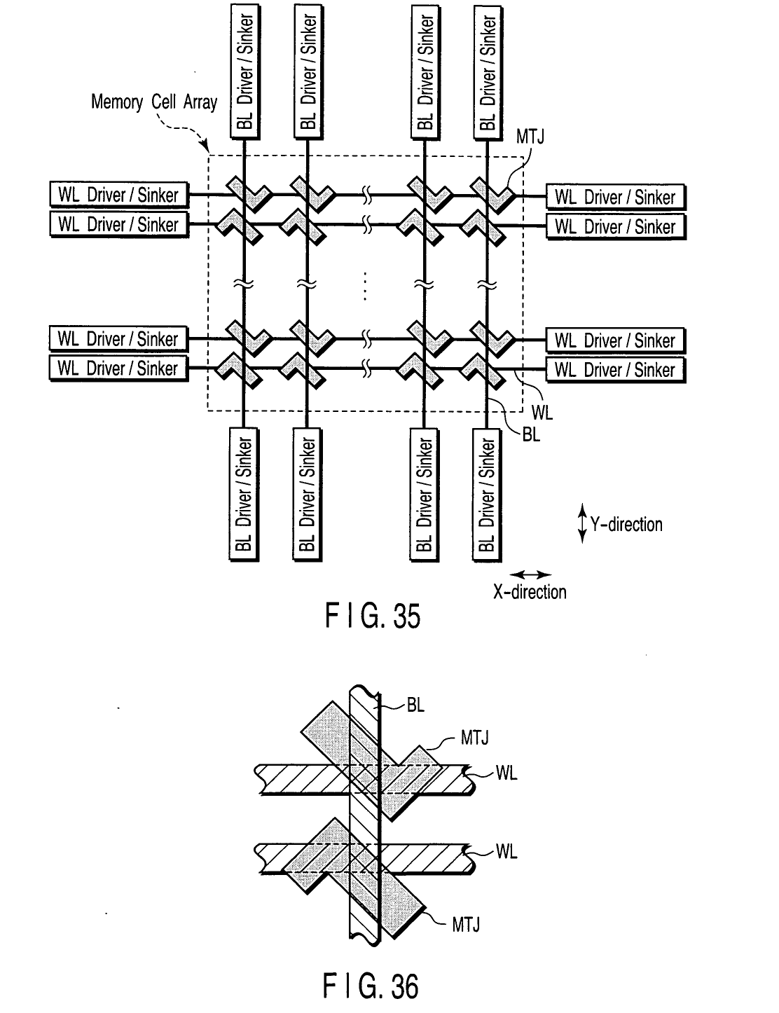

FIGS. 35 and 36 show outlines of a memory cell array of the magnetic random access memory according to the thirteenth embodiment.

The memory cell array comprises a plurality of magnetoresistive elements MTJ arranged in an array state. In the memory cell array, a plurality of word lines WL extending in an X-direction and a plurality of bit lines BL extending in a Y-direction are arranged.

Opposite ends of the plurality of word lines WL are connected to, for example, a plurality of word line drivers/sinkers (WL drivers/sinkers), and opposite ends of the plurality of bit lines BL are connected to a plurality of bit line drivers/sinkers (BL drivers/sinkers).

Here, the magnetic random access memory according to the thirteenth embodiment is different from the magnetic random access memory (FIG. 23) according to the tenth embodiment that magnetic anisotropy of a main body of a magnetoresistive element MTJ is set to a direction of an angle of 45° with respect to a direction in which a word line WL or a bit line BL right under or right on the magnetoresistive element MTJ extends.

In this case, by application of a toggle write system having an advantage that write selection property is secured while a value of a write current can be reduced, there can be provided a high-performance magnetic random access memory.

### (14) Fourteenth Embodiment

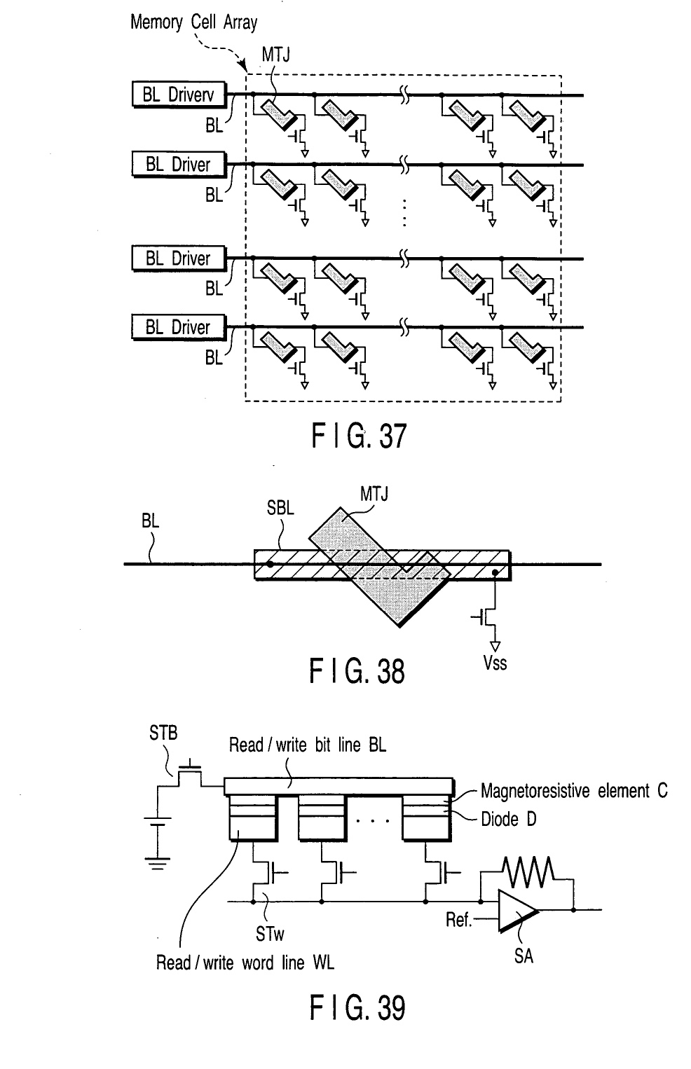

FIGS. 37 and 38 show outlines of a memory cell array of a magnetic random access memory according to a fourteenth embodiment.

The magnetic random access memory of the present embodiment adopts a so-called uniaxial write system in which data is written with respect to one magnetoresistive element (MTJ element) using one write line.

The memory cell array comprises a plurality of magnetoresistive elements MTJ arranged in an array state. In the memory cell array, a plurality of bit lines BL extending in an X-direction are arranged.

For example, a plurality of bit line drivers (BL drivers) are connected to one end of the plurality of bit lines BL. Each of the plurality of bit lines BL is connected to one end of a plurality of sub-bit lines SBL.

A magnetoresistive element MTJ is disposed right on or right under the sub-bit line SBL. The magnetoresistive elements MTJ are arranged in such a manner that magnetic anisotropy of each main body forms a predetermined angle (e.g., 45°) with respect to the extending direction of the sub-bit line SBL.

The other end of the sub-bit line SBL is connected to a ground point via a selection element (e.g., MOS transistor).

Layouts of free layers, pinned layers, and bottom electrodes may be set as shown in FIGS. 15 to 18, or FIGS. 21 and 22.

According to the magnetic random access memory of the uniaxial write system of the fourteenth embodiment, the data can be written with respect to one magnetoresistive element MTJ using only one write line. Therefore, the present embodiment can contribute to an increase of memory capacity by high integration.

Additionally, disturbance defects of a memory cell in a so-called half-selection state at the time of a write operation can be reduced.

### (15) Fifteenth Embodiment

A fifteenth embodiment relates to a read circuit of a magnetic random access memory to which a magnetoresistive element according to an example of the present invention is applied.

FIG. 39 shows a cross point type memory cell array.

A read/write word line WL intersects a read/write bit line BL, and a magnetoresistive element C is disposed in the intersecting portion. The magnetoresistive element C is electrically connected to the read/write word line WL and the read/write bit line BL.

A diode D is disposed between the magnetoresistive element C and the read/write word line WL. Each diode D has a function of preventing a so-called sneak current peculiar to the cross point type memory cell array at the time of reading/writing. The sneak current is avoided, for example, when bias voltages are supplied to this diode D, non-selected read/write word line WL, and non-selected read/write bit line BL.

The read/write word line WL is connected to, for example, a sense amplifier SA via a selected transistor STw. The read/write bit line BL is connected to, for example, a power supply via a selected transistor STB.

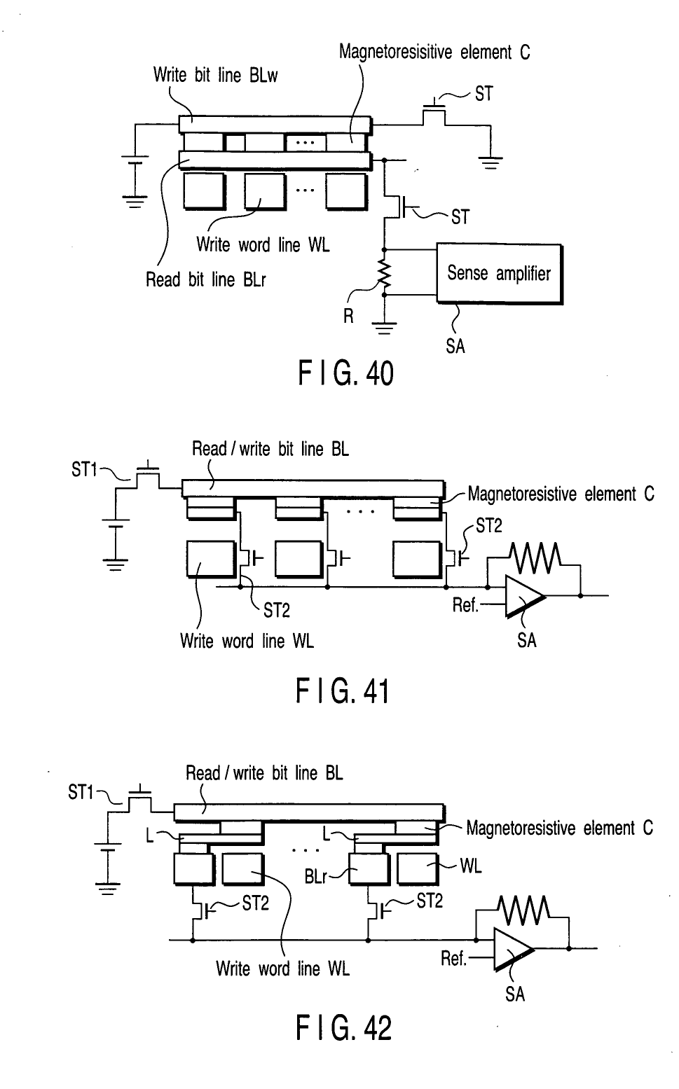

FIG. 40 shows a ladder type memory cell array.

A plurality of magnetoresistive elements C are arranged in a ladder form between a write bit line BLw and a read bit line BLr. The write bit line BLw and the read bit line BLr extend in the same direction.

Write word lines WL are arranged right under the magnetoresistive elements C. The write word lines WL are arranged apart from the magnetoresistive elements C by a constant distance, and extend in a direction intersecting the write bit line BLw.

The read bit line BLr is connected to, for example, a resistance element R via a selected transistor ST. The sense amplifier SA detects voltages generated in opposite ends of the resistance element R to thereby sense read data. One end of the write bit line BLw is connected to a power supply, and the other end thereof is connected to, for example, a ground point via the selected transistor ST.

FIGS. 41 and 42 show one-transistor 1MTJ type memory cell arrays.

A write word line WL intersects a read/write bit line BL, and a magnetoresistive element C is disposed in the intersecting portion. The magnetoresistive element C is electrically connected to the read/write bit line BL. A write word line WL is disposed right under the magnetoresistive element C. The write word line WL is distant from the magnetoresistive element C by a constant distance.

One end of the magnetoresistive element C is connected to, for example, a sense amplifier SA via a selected transistor ST2. The read/write bit line BL is connected to a power supply via a selected transistor ST1.

It should be noted that in a structure of FIG. 42, one end of the magnetoresistive element C is connected to a bottom electrode L which is an outgoing line. Therefore, even when the selected transistor ST2 is disposed right under the magnetoresistive element C, the word line WL can be disposed in the vicinity of the magnetoresistive element C.

The representative examples of the magnetic random access memory to which the magnetoresistive element according to the example of the present invention is applied have been described above, but the example of the present invention is also applicable to a magnetic random access memory other than these representative examples.

It should be noted that a magnetization easy axis direction of the magnetoresistive element may be parallel to the write word line or the write bit line. The magnetization easy axis direction of the magnetoresistive element may be directed in a direction of 45° with respect to the extending directions of two write lines (write word/bit lines).

4. Others

According to an example of the present invention, a free layer whose magnetization direction changes in accordance with a magnetic field comprises a main body portion having magnetic anisotropy in a long-axis direction, and one jut portion jutting from the main body portion and having magnetic anisotropy in a direction different from the long-axis direction.

Therefore, when a magnetic field is applied to a magnetoresistive element at the time of writing of data, first reversing of magnetization of the jut portion proceeds, this performs a tractive function, and the reversing of the magnetization of the main body portion also proceeds following the reversing of the magnetization of the jut portion.

The jut portion assists the reversing of the magnetization of the main body portion in this manner. Therefore, as a result, an asteroid curve of the magnetoresistive element can be dented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A magnetoresistive element comprising:
a first ferromagnetic layer whose magnetization direction is fixed; and
a second ferromagnetic layer whose magnetization direction changes in accordance with an applied magnetic field,
wherein the second ferromagnetic layer comprises: a main body having a long-axis direction; and a jut which juts from the main body in a direction different from the long-axis direction.

2. The magnetoresistive element according to claim 1, wherein the second ferromagnetic layer is asymmetric with respect to the long-axis.

3. The magnetoresistive element according to claim 1, wherein the long-axis direction is the same as the magnetization direction of the first ferromagnetic layer, and the short-axis direction of the main body is different from the magnetization direction of the first ferromagnetic layer.

4. The magnetoresistive element according to claim 1, wherein the long-axis direction is different from the magnetization direction of the first ferromagnetic layer.

5. The magnetoresistive element according to claim 1, wherein the main body has shape magnetic anisotropy in the long-axis direction.

6. The magnetoresistive element according to claim 5, wherein the jut has shape magnetic anisotropy in a direction different from the long-axis direction.

7. The magnetoresistive element according to claim 6, wherein a size of the jut is smaller than that of the main body.

8. The magnetoresistive element according to claim 7, wherein both the main body and the jut have rectangular shapes.

9. The magnetoresistive element according to claim 7, wherein the main body has a shape whose at least one corner is cut off in such a manner that a tip of a rectangular shape is tapered.

10. The magnetoresistive element according to claim 7, wherein corners and connected portions of the main body and the jut are rounded.

11. The magnetoresistive element according to claim 1, wherein a shape of the second ferromagnetic layer is different from that of the first ferromagnetic layer.

12. The magnetoresistive element according to claim 1, wherein a shape of the second ferromagnetic layer is the same as that of the first ferromagnetic layer.

13. A magnetic random access memory comprising:
a plurality of magnetoresistive elements each comprising a first ferromagnetic layer whose magnetization direction is fixed, and a second ferromagnetic layer whose magnetization direction changes in accordance with an applied magnetic field, the plurality of magnetoresistive elements being arranged in an array state; and
a plurality of first write lines each extending a first direction and for use in write data with respect to one of the plurality of magnetoresistive elements,
wherein the second ferromagnetic layer comprises: a main body having a long-axis direction; and a jut which juts from the main body in a direction different from the long-axis direction.

14. The magnetic random access memory according to claim 13, wherein the plurality of magnetoresistive elements are all directed in the same direction.

15. The magnetic random access memory according to claim 13, wherein the magnetoresistive elements connected to the two first write lines adjacent in a second direction intersecting the first direction are point-symmetrically or line-symmetrically arranged.

16. The magnetic random access memory according to claim 13, wherein the long-axis direction is different from a direction in which the plurality of first write lines extend.

17. The magnetic random access memory according to claim 13, wherein the plurality of first write lines are arranged in adjacent to the main body, and extend in the long-axis direction.

18. The magnetic random access memory according to claim 13, further comprising:
a plurality of second write lines intersecting the plurality of first write lines,
wherein the plurality of second write lines are arranged in adjacent to the jut, and extend in the long-axis direction or the short-axis direction of the main body.

19. The magnetic random access memory according to claim 13, further comprising:
a plurality of second write lines intersecting the plurality of first write lines,
wherein the plurality of second write lines are arranged in adjacent to the main body, and extend in the long-axis direction or the short-axis direction of the main body.

20. A magnetoresistive element comprising:
a first ferromagnetic layer whose magnetization direction is fixed; and
a second ferromagnetic layer whose magnetization direction changes in accordance with an applied magnetic field,
wherein the second ferromagnetic layer comprises: a main body having a long-axis direction; and a jut jutting in the short-axis direction of the main body from a middle of the main body, and
a size of the jut is smaller than that of the main body.
